(19) United States
(12) Patent Application Publication
(10) Pub. No.: US 2025/0219304 A1
(43) Pub. Date: Jul. 3, 2025

(54) REEL BODY

(71) Applicant: Resonac Corporation, Minato-ku, Tokyo (JP)

(72) Inventors: Tetsuyuki SHIRAKAWA, Tokyo (JP); Katsuhiko TOMISAKA, Tokyo (JP); Takahiro FUKUI, Tokyo (JP)

(21) Appl. No.: 19/083,439

(22) Filed: Mar. 19, 2025

Related U.S. Application Data
(62) Division of application No. 17/905,415, filed on Sep. 1, 2022.

(30) Foreign Application Priority Data
Mar. 4, 2020 (JP) 2020-037070

(51) Int. Cl. H01R 4/04; B65H 75/02; C09J 7/10; C09J 9/02

(52) U.S. Cl. CPC H01R 4/04; B65H 75/02; C09J 7/10; C09J 9/02; C09J 2203/326; C09J 2301/408; C09J 2461/00

(57) ABSTRACT

A reel body containing: a winding core; and an adhesive tape wound around the winding core, wherein the adhesive tape contains a support and an adhesive film provided on the support, wherein the adhesive film contains an adhesive layer, wherein the adhesive layer contains an adhesive component and a plurality of conductive particles, wherein the plurality of conductive particles contain: first conductive particles that are dendritic conductive particles; and second conductive particles that are conductive particles other than the first conductive particles, each second conductive particle containing a non-conductive core and a conductive layer provided on the core, wherein a part of the plurality of conductive particles protrudes from one surface of the adhesive layer, and wherein the support faces a surface of the adhesive layer opposite to the one surface thereof.

### CROSS-REFERENCE TO RELATED APPLICATIONS

This application is a divisional application of U.S. application Ser. No. 17/905,415, filed on Sep. 1, 2022, which is a 35 U.S.C. § 371 national phase application of PCT/JP2021/008264, filed on Mar. 3, 2021, which claims priority to Japanese Patent Application No. 2020-037070, filed on Mar. 4, 2020.

### TECHNICAL FIELD

The present invention relates to an adhesive film and a reel body.

### BACKGROUND ART

In recent years, various adhesives have been used in the fields of semiconductors, liquid crystal displays, and the like for fixing electronic components, connecting circuits, and the like. In these applications, higher integration density and higher fineness of electronic components, circuits, and the like are progressed, and adhesives are also required to have a higher level of performance.

For example, in Patent Literature 1, a main object is to provide an adhesive composition capable of obtaining excellent conductivity at the time of connection even at a low pressure and suppressing outflow of the adhesive component at the time of connection, and there is disclosed an adhesive composition containing: a first conductive particle that is a dendritic conductive particle; and a second conductive particle that is a conductive particle other than the first conductive particle and is a conductive particle having a non-conductive core and a conductive layer provided on the core.

### CITATION LIST

### Patent Literature

Patent Literature 1: International Publication WO 2018/043505

### SUMMARY OF INVENTION

### Technical Problem

Incidentally, the adhesive as described above is usually distributed in the form of a reel body (adhesive reel) obtained by molding the adhesive in a film shape (tape shape), providing the film-shaped adhesive on a support, and winding the film-shaped adhesive around a core. In the reel body, a phenomenon in which the adhesive is attached to an unintended place (blocking phenomenon) may occur, and when the adhesive film (adhesive tape) is drawn, for example, the adhesive film is peeled off from the support, and thus the adhesive film cannot be drawn. According to the studies of the present inventors, there is still room for improvement in anti-blocking property in the adhesive described in Patent Literature 1 above.

Therefore, an object of the present invention is to provide an adhesive film and a reel body which are excellent in anti-blocking property.

### Solution to Problem

An aspect of the present invention is an adhesive film including a first adhesive layer, in which the first adhesive layer contains a first adhesive component and a plurality of conductive particles, in which the plurality of conductive particles include first conductive particles that are dendritic conductive particles, and second conductive particles that are conductive particles other than the first conductive particles, each conductive particle having a non-conductive core and a conductive layer provided on the core, and a part of the plurality of conductive particles is disposed to protrude from one surface of the first adhesive layer.

In the adhesive film, the first conductive particles may be disposed to protrude from the one surface of the first adhesive layer, the second conductive particles may be disposed to protrude from the one surface of the first adhesive layer, or the first conductive particles and the second conductive particles may be disposed to protrude from the one surface of the first adhesive layer. The adhesive film may further include a second adhesive layer that is provided on the one surface of the first adhesive layer and contains a second adhesive component different from the first adhesive component. The first adhesive layer may have a thickness of 10 μm or more, and the second adhesive layer may have a thickness of 5 μm or less.

Another aspect of the present invention is a reel body including: a winding core; and an adhesive tape wound around the winging core, in which the adhesive tape has a support and the above-described adhesive film provided on the support such that the other surface of the first adhesive layer faces the support side.

### Advantageous Effects of Invention

According to an aspect of the present invention, it is possible to provide an adhesive film and a reel body which are excellent in anti-blocking property.

Furthermore, in a conventional adhesive as described in Patent Literature 1, in a case where the composition of the adhesive is changed to a composition for obtaining a higher adhesive force, a blocking phenomenon is likely to occur; however, according to another aspect of the present invention, excellent anti-blocking property is obtained even in the case of an adhesive film with a further improved adhesive force.

### BRIEF DESCRIPTION OF DRAWINGS

FIG. 1 is a cross-sectional view illustrating an embodiment of an adhesive film.

FIG. 2 is a cross-sectional view illustrating another embodiment of the adhesive film.

FIG. 3 is a perspective view illustrating an embodiment of a reel body.

FIG. 4 is a diagram for describing a method for evaluating connection resistance in Examples.

### DESCRIPTION OF EMBODIMENTS

Hereinafter, embodiments of the present invention will be specifically described with reference to the drawings as appropriate. Note that, in the present specification, a numerical range that has been indicated by use of “to” indicates the range that includes the numerical values which are described before and after “to” as the minimum value and the maximum value, respectively. Furthermore, an upper limit value and a lower limit value each separately described can be arbitrarily combined.

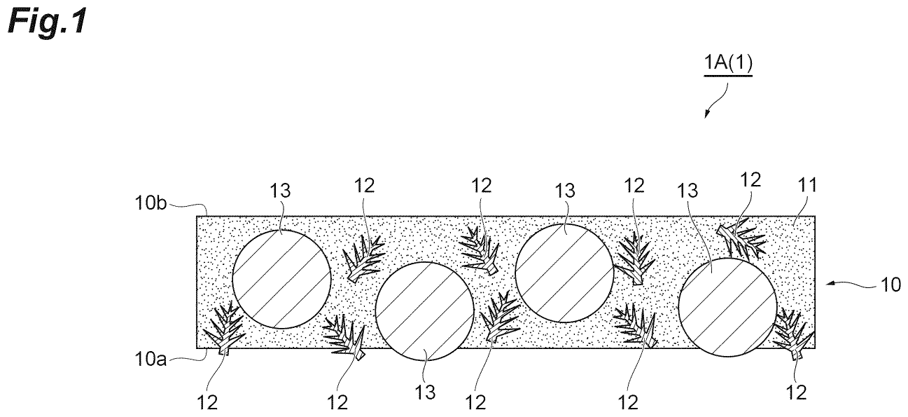

FIG. 1 is a cross-sectional view illustrating an embodiment of an adhesive film. As illustrated in FIG. 1, an adhesive film 1A (1) according to an embodiment includes a first adhesive layer 10. The first adhesive layer 10 contains a first adhesive component 11, and first conductive particles 12 and second conductive particles 13 which are dispersed in the first adhesive component 11.

The first adhesive component 11 is configured, for example, by a material exhibiting curability by heat or light, and may be an epoxy-based adhesive, a radically curable adhesive, a thermoplastic adhesive, which contains polyurethane, polyvinyl ester, or the like, and the like. The first adhesive component 11 is excellent in heat resistance and moisture resistance after adhesion, and thus may be configured by a crosslinkable material. The epoxy-based adhesive contains an epoxy resin which is a thermosetting resin as a main component. The epoxy-based adhesive is preferably used from the viewpoint that the epoxy-based adhesive can be cured in a short time, has good connection workability, is excellent in adhesiveness, and the like. The radically curable adhesive has properties such as being excellent in curability at a low temperature in a short time as compared with the epoxy-based adhesive, and thus is appropriately used according to the application.

The epoxy-based adhesive contains, for example, an epoxy resin (thermosetting material) and a curing agent, and may further contain a thermoplastic resin, a coupling agent, a filler, and the like, as necessary.

Examples of the epoxy resin include a bisphenol A type epoxy resin, a bisphenol F type epoxy resin, a bisphenol S type epoxy resin, a phenol novolak type epoxy resin, a cresol novolak type epoxy resin, a bisphenol A novolak type epoxy resin, a bisphenol F novolak type epoxy resin, an alicyclic epoxy resin, a glycidyl ester type epoxy resin, a glycidyl amine type epoxy resin, a hydantoin type epoxy resin, an isocyanurate type epoxy resin, and an aliphatic chain epoxy resin. These epoxy resins may be halogenated or hydrogenated, and may have a structure in which an acryloyl group or a methacryloyl group is added to a side chain. These epoxy resins are used singly or in combinations of two or more kinds thereof.

The curing agent is not particularly limited as long as it can cure the epoxy resin, and examples thereof include anionic polymerizable catalyst-type curing agents, cationic polymerizable catalyst-type curing agents, and polyaddition-type curing agents. Among these, from the viewpoint that fast curability is excellent and consideration in regard to chemical equivalents is not required, anionic and cationic polymerizable catalyst-type curing agents are preferred.

Examples of the anionic and cationic polymerizable catalyst-type curing agents include imidazole, hydrazide, boron trifluoride-amine complexes, onium salts (such as an aromatic sulfonium salt, an aromatic diazonium salt, and an aliphatic sulfonium salt), amineimides, diaminomaleonitriles, melamine and its derivatives, polyamine salts, and dicyandiamides, and modified forms thereof can also be used. Examples of the polyaddition-type curing agent include polyamine, polymercaptan, polyphenol, and acid anhydride.

These curing agents may be latent curing agents obtained by microcapsulating these curing agents with polymer substances such as polyurethane-based and polyester-based substances, metal thin films of nickel, copper, and the like, inorganic substances such as calcium silicate, and the like coated. The latent curing agents are preferred since the pot life can be extended. The curing agents are used singly or in combinations of two or more kinds thereof.

The content of the curing agent may be 0.05 to 20 parts by mass with respect to 100 parts by mass of the total amount of the thermosetting material and the thermoplastic resin that is blended as necessary.

The radically curable adhesive contains, for example, a radical polymerizable material and a radical polymerization initiator (also called a curing agent), and may further contain a thermoplastic resin, a coupling agent, a filler, and the like as necessary.

As the radical polymerizable material, for example, any substance having a functional group which is polymerized by radical can be used without particular limitation. Specific examples thereof include radical polymerizable materials such as an acrylate (including corresponding methacrylate; the same applies hereinafter) compound, an acryloxy (including corresponding methacryloxy; the same applies hereinafter) compound, a maleimide compound, a citraconimide resin, and a nadimide resin. These radical polymerizable materials may be in a state of a monomer or an oligomer, or may be in a mixture state of a monomer and an oligomer.

Examples of the acrylate compound include methyl acrylate, ethyl acrylate, isopropyl acrylate, isobutyl acrylate, ethylene glycol diacrylate, diethylene glycol diacrylate, trimethylolpropane triacrylate, tetramethylolmethane tetraacrylate, 2-hydroxy-1,3-diacryloxypropane, 2,2-bis [4-(acryloxymethoxy)phenyl]propane, 2,2-bis [4-(acryloxypolyethoxy)phenyl]propane, dicyclopentenyl acrylate, tricyclodecanyl acrylate, tris(acryloyloxyethyl) isocyanurate, urethane acrylate, and phosphoric acid ester diacrylate.

The radical polymerizable material such as an acrylate compound may be used together with a polymerization inhibitor such as hydroquinone or methyl ether hydroquinone as necessary. The radical polymerizable material such as an acrylate compound preferably has at least one substituent such as a dicyclopentenyl group, a tricyclodecanyl group, and a triazine ring, from the viewpoint of improving heat resistance. As the radical polymerizable material other than the acrylate compound, for example, the compounds described in International Publication WO 2009/063827 can be suitably used. The radical polymerizable materials are used singly or in combinations of two or more kinds thereof.

As the radical polymerization initiator, for example, any compound capable of decomposing upon heating or irradiation with light to generate radicals can be used without particular limitation. Specific examples thereof include a peroxide compound and an azo-based compound. These compounds are appropriately selected depending on target connection temperature, connection time, pot life, and the like.

More specific examples of the radical polymerization initiator include diacyl peroxide, peroxy dicarbonate, peroxy ester, peroxy ketal, dialkyl peroxide, hydroperoxide, and silyl peroxide. Among these, peroxy ester, dialkyl peroxide, hydroperoxide, silyl peroxide, and the like are preferred, and peroxy ester which can provide high reactivity is more preferred. As these radical polymerization initiators, for example, the compounds described in International Publication WO 2009/063827 can be suitably used. The radical polymerization initiators are used singly or in combinations of two or more kinds thereof.

The content of the radical polymerization initiator may be 0.1 parts by mass or more and may be 10 parts by mass or less with respect to 100 parts by mass of the total amount of the radical polymerizable material and the thermoplastic resin that is blended as necessary.

The thermoplastic resin that is blended as necessary in the epoxy-based adhesive and the radically curable adhesive makes it easy to mold the adhesive into a film shape, for example. Examples of the thermoplastic resin include a phenoxy resin, a polyvinyl formal resin, a polystyrene resin, a polyvinyl butyral resin, a polyester resin, a polyamide resin, a xylene resin, a polyurethane resin, a polyester urethane resin, a phenol resin, and a terpene phenol resin. As the thermoplastic resin, for example, the compounds described in International Publication WO 2009/063827 can be suitably used. Among these, from the viewpoint of excellent adhesiveness, compatibility, heat resistance, mechanical strength, and the like, a phenoxy resin is preferred. The thermoplastic resins are used singly or in combinations of two or more kinds thereof.

The content of the thermoplastic resin in the case of being blended in the epoxy-based adhesive may be 5 parts by mass or more and may be 80 parts by mass or less with respect to 100 parts by mass of the total amount of the thermoplastic resin and the thermosetting material. The content of the thermoplastic resin in the case of being blended in the radically curable adhesive may be 5 parts by mass or more and may be 80 parts by mass or less with respect to 100 parts by mass of the total amount of the thermoplastic resin and the radical polymerizable material.

Another example of the first adhesive component 11 includes a thermal radical curable adhesive containing a thermoplastic resin, a radical polymerizable material in a liquid state at 30° C., and a radical polymerization initiator. The thermal radical curable adhesive has a lower viscosity than the above-described adhesive. The content of the radical polymerizable material in the thermal radical curable adhesive may be 20 parts by mass or more, 30 parts by mass or more, or 40 parts by mass or more, and may be 80 parts by mass or less with respect to 100 parts by mass of the total amount of the thermoplastic resin and the radical polymerizable material.

The first adhesive component 11 may be an epoxy-based adhesive that contains a thermoplastic resin, a thermosetting material containing an epoxy resin in a liquid state at 30° C., and a curing agent. In this case, the content of the epoxy resin in the epoxy-based adhesive may be 20 parts by mass or more, 30 parts by mass or more, or 40 parts by mass or more, and may be 80 parts by mass or less with respect to 100 parts by mass of the total amount of the thermoplastic resin and thermosetting material.

The volume ratio of the first adhesive component 11 occupied in the first adhesive layer 10 may be, for example, 55% by volume or more, or 65% by volume or more, and may be 95% by volume or less or 85% by volume or less on the basis of the total volume of the first adhesive layer 10.

The first conductive particle 12 has a dendritic shape (also referred to as a dendrite shape) and includes one main shaft and a plurality of branches that two-dimensionally or three-dimensionally branch from the main shaft. The first conductive particle 12 may be formed from a metal such as copper or silver, and may be, for example, a silver-coated copper particle in which a copper particle is coated with silver.

The first conductive particle 12 may be known, and as specific examples, ACBY-2 (MITSUI MINING & SMELTING CO., LTD.), CE-1110 (FUKUDA METAL FOIL & POWDER CO., LTD.), #FSP (JX Nippon Mining & Metals Corporation), #51-R (JX Nippon Mining & Metals Corporation), and the like are available. Alternatively, the first conductive particle 12 can also be produced by a known method (for example, the method described in International Publication WO 2014/021037).

The content of the first conductive particle 12 in the first adhesive layer 10 (the volume ratio of the first conductive particle 12 occupied in the first adhesive layer 10) is preferably 10% by volume or more, more preferably 20% by volume or more, and further preferably 30% by volume or more from the viewpoint of further reducing the resistance of a connection body, and is preferably 60% by volume or less, more preferably 55% by volume or less, and further preferably 50% by volume or less from the viewpoint of improving the adhesive force of the adhesive film, on the basis of the total volume of the first adhesive layer 10.

The second conductive particle 13 may have, for example, a non-conductive core and a conductive layer provided on the core. The core is formed from a non-conductive material such as glass, ceramic, and a resin, and is preferably formed from a resin. Examples of the resin include an acrylic resin, a styrene resin, a silicone resin, a polybutadiene resin, or copolymers of monomers constituting these resins. The average particle diameter of the core is appropriately selected so that the average particle diameter of the second conductive particles 13 is in a range described below.

The conductive layer is formed, for example, from gold, silver, copper, nickel, palladium, or an alloy thereof. From the viewpoint of excellent conductivity, the conductive layer preferably contains at least one selected from gold, nickel, and palladium, more preferably contains gold or palladium, and further preferably contains gold. The conductive layer is formed, for example, by plating the above-described metal on the core. The thickness of the conductive layer may be, for example, 10 nm or more, and may be 400 nm or less.

The average particle diameter of the second conductive particles 13 may be, for example, 10 μm or more, 20 μm or more, or 30 μm or more, and may be 50 μm or less, 45 μm or less, or 40 μm or less. The average particle diameter of each of the second conductive particles 13 and the core constituting the second conductive particle 13 is measured by a particle size distribution measuring apparatus (Microtrac (product name, NIKKISO CO., LTD.)) using a laser diffraction-scattering method.

The content of the second conductive particle 13 in the first adhesive layer 10 (the volume ratio of the second conductive particle 13 occupied in the first adhesive layer 10) may be 2% by volume or more or 5% by volume or more, and may be 20% by volume or less or 10% by volume or less on the basis of the total volume of the first adhesive layer 10.

The thickness of the first adhesive layer 10 may be, for example, 10 μm or more, 20 μm or more, or 30 μm or more, and may be 50 μm or less, 45 μm or less, or 40 μm or less. Note that, the thickness of the first adhesive layer 10 is defined as the thickness of the first adhesive layer 10 at a place, from which the first conductive particles 12 and the second conductive particles 13 do not protrude, of one surface 10a of the first adhesive layer 10.

In this adhesive film 1A, as illustrated in FIG. 1, a part of the plurality of first conductive particles 12 and the second conductive particles 13 contained in the first adhesive layer 10 (the first conductive particles 12 and the second conductive particles 13 existing near the one surface 10a of the first adhesive layer 10) are disposed to protrude from the one surface 10a of the first adhesive layer 10. As such, when the adhesive film 1A is used in the form of a reel body, excellent anti-blocking property is obtained (the details thereof will be described below).

In order to cause the first conductive particles 12 and the second conductive particles 13 to protrude from the one surface 10a of the first adhesive layer 10 in this way, for example, the type of the solvent to be used when the first adhesive layer 10 is formed, drying conditions when the solvent is removed, and the like may be adjusted. Specifically, the first adhesive layer 10 is formed, for example, by applying a mixed solution containing the first conductive particles 12, the second conductive particles 13, and the first adhesive component 11 dissolved in a solvent to a support and then removing the solvent, but as the boiling point of the solvent used at this time is lower, the first conductive particles 12 and the second conductive particles 13 are likely to protrude from the one surface 10a of the first adhesive layer 10. Furthermore, as the drying conditions when the solvent is removed are a higher temperature and a shorter time, the first conductive particles 12 and the second conductive particles 13 are likely to protrude from the one surface 10a of the first adhesive layer 10.

In the above-described embodiment, both the first conductive particles 12 and the second conductive particles 13 are disposed to protrude from the one surface 10a of the first adhesive layer 10, but a part of a plurality of conductive particles contained in the first adhesive layer 10 may be disposed to protrude from the one surface 10a of the first adhesive layer 10, and for example, only the first conductive particles 12 may be disposed to protrude from the one surface 10a of the first adhesive layer 10, or only the second conductive particles 13 may be disposed to protrude from the one surface 10a of the first adhesive layer 10.

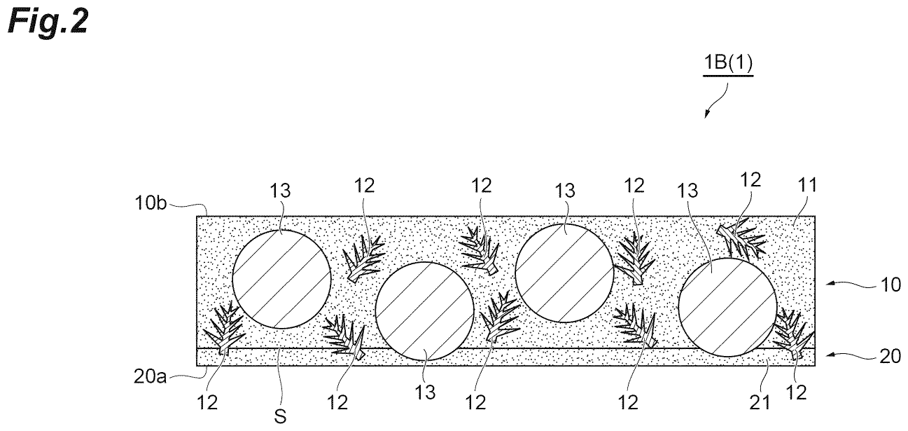

In the above-described embodiment, the adhesive film 1A includes only one layer of the first adhesive layer 10, but in another embodiment, the adhesive film 1 may include two or more layers. FIG. 2 is a cross-sectional view illustrating another embodiment of the adhesive film 1. As illustrated in FIG. 2, an adhesive film 1B (1) according to another embodiment may further include a second adhesive layer 20 provided on the one surface 10a of the first adhesive layer 10, in addition to the above-described first adhesive layer 10.

The second adhesive layer 20 contains, for example, a second adhesive component 21. The second adhesive layer 20 may not contain conductive particles. The second adhesive component 21 may be configured by a material selected from the materials exemplified as the first adhesive component 11, but is different from the first adhesive component 11 (has a different composition). From the viewpoint of excellent bonding property when the adhesive film 1B is bonded to an object to be bonded, the second adhesive layer 20 (the second adhesive component 21) preferably has a higher adhesive force than the adhesive force of the first adhesive layer 10 (the first adhesive component 11).

Specifically, for example, the melt viscosity at 25° C. of the second adhesive layer 20 is preferably lower than the melt viscosity at 25° C. of the first adhesive layer 10. The melt viscosity at 25° C. of the first adhesive layer 10 may be, for example, 1×10⁴ Pa·s or more, 5×10⁴ Pa·s or more, or 1×10⁵ Pa·s or more. The melt viscosity at 25° C. of the second adhesive layer 20 may be less than 1×10⁴ Pa·s, 7×10⁴ Pa·s or less, or 5×10⁵ Pa·s or less. The melt viscosity of each adhesive layer is measured in such a manner that a measurement sample obtained by laminating respective adhesive layers to have a thickness of 500 μm is cut into 10 mm×10 mm (thickness: 500 μm), and the melt viscosity of the cut measurement sample is measured under the conditions of a measurement frequency of 10 Hz and a temperature increase rate of 10° C./min using a film melt viscosity measuring apparatus (for example, trade name: ARES-G2, manufactured by TA Instruments).

The thickness of the second adhesive layer 20 is preferably thinner than the thickness of the first adhesive layer 10 from the viewpoint of further suitably obtaining the effect of anti-blocking property. The thickness of the second adhesive layer 20 may be, for example, 0.5 μm or more, 1 μm or more, 1.5 μm or more, or 2 μm or more, and is preferably 5 μm or less, more preferably 4 μm or less, and further preferably 3 μm or less. Note that, the thickness of the second adhesive layer 20 is defined as the thickness of the second adhesive layer 20 at a place, from which the first conductive particles 12 and the second conductive particles 13 do not protrude, of the one surface 10a of the first adhesive layer 10.

This adhesive film 1B includes, as illustrated in FIG. 2, the second adhesive layer 20, and thus when the adhesive film 1B is used in the form of a reel body, excellent anti-blocking property is obtained (the details thereof will be described below).

In the above-described embodiment, both the first conductive particles 12 and the second conductive particles 13 are disposed to protrude from an interface S between the first adhesive layer 10 and the second adhesive layer 20 toward the second adhesive layer 20, but a part of a plurality of conductive particles contained in the first adhesive layer 10 may be disposed to protrude from the interface S between the first adhesive layer 10 and the second adhesive layer 20 toward the second adhesive layer 20, and for example, only the first conductive particles 12 may be disposed to protrude from the interface S between the first adhesive layer 10 and the second adhesive layer 20 toward the second adhesive layer 20, or only the second conductive particles 13 may be disposed to protrude from the interface S between the first adhesive layer 10 and the second adhesive layer 20 toward the second adhesive layer 20.

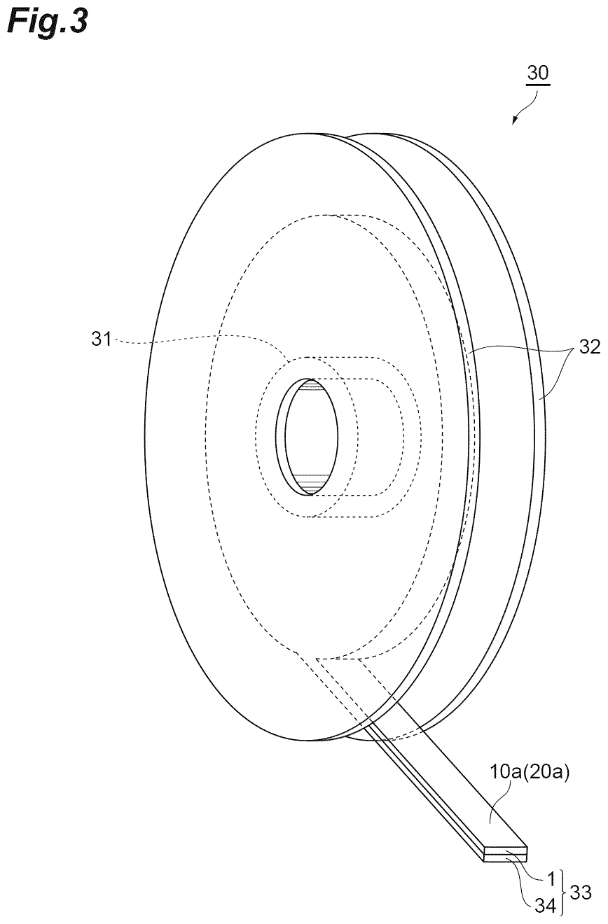

The adhesive film 1 described above is excellent in anti-blocking property, and thus is suitably used in the form of a reel body (adhesive reel). FIG. 3 is a perspective view illustrating an embodiment of a reel body. As illustrated in FIG. 3, a reel body 30 according to an embodiment includes a cylindrical winding core 31, disk-shaped side plates 32 which are provided on both end faces in a shaft direction of the winding core 31, and an elongated adhesive tape 33 which is wound on the winding core 31 to constitute a wound body. The adhesive tape 33 includes an elongated support 34 and the adhesive film 1. The adhesive film 1 has an elongated shape that is substantially the same as that of the support 34.

The length of the support 34 may be, for example, 1 to 400 m. The thickness of the support 34 may be, for example, 4 to 200 μm. The width of the support 34 may be, for example, 0.5 to 30 mm. The support 34 may be formed, for example, from a polymer such as a polyethylene terephthalate, a polyethylene naphthalate, a polyethylene isophthalate, a polybutylene telephthalate, a polyolefin, a polyacetate, a polycarbonate, a polyphenylene sulfide, a polyamide, an ethylene-vinyl acetate copolymer, a polyvinyl chloride, a polyvinylidene chloride, a synthetic rubber, and a liquid crystal polymer.

In the reel body 30, the adhesive film 1 is provided on the support 34 such that the other surface of the first adhesive layer 10 (the surface opposite to the surface from which the first conductive particles 12 and the second conductive particles 13 protrude) faces the support 34. In other words, in a case where the adhesive film 1 is the adhesive film 1A illustrated in FIG. 1, the adhesive film 1A is provided on the support 34 such that the one surface (the surface from which the first conductive particles 12 and the second conductive particles 13 protrude) 10a of the first adhesive layer 10 faces the side opposite to the support 34. In a case where the adhesive film 1 is the adhesive film 1B illustrated in FIG. 2, the adhesive film 1B is provided on the support 34 such that a surface 20a of the second adhesive layer 20 on the side opposite to the first adhesive layer 10 faces the side opposite to the support 34.

In this reel body 30, even when the adhesive force of the adhesive film 1 is equal, excellent anti-blocking property is obtained. In a case where the adhesive film 1 is the adhesive film 1A illustrated in FIG. 1, the adhesive tape in the reel body 30 is wound such that the one surface (the surface from which the first conductive particles 12 and the second conductive particles 13 protrude) 10a of the first adhesive layer 10 is in contact with a rear surface of the support 34 (the surface opposite to the surface on which the first adhesive layer 10 is provided) in the adhesive tape wound inwardly by one reel. At this time, since the first conductive particles 12 and the second conductive particles 13 protrude from the one surface 10a of the first adhesive layer 10, the first adhesive component 11 is difficult to be attached to a rear surface 34a of the support 34 in an adhesive tape 33A wound inwardly by one reel (the first conductive particles 12 and the second conductive particles 13 which protrude play a role as a spacer between the one surface 10a of the first adhesive layer 10 and the rear surface 34a of the support 34, and a distance therebetween is easily maintained). Therefore, in the reel body 30 including the adhesive film 1A, even when the adhesive force of the adhesive film 1 (the first adhesive component 11) is equal, excellent anti-blocking property (particularly, anti-blocking property to the rear surface 34a of the support 34 in the adhesive tape 33A wound inwardly by one reel) is obtained. Such an effect may be exhibited similarly even in a case where the adhesive force of the adhesive film 1 (the first adhesive component 11) is increased.

Furthermore, in a case where the adhesive film 1 is the adhesive film 1B illustrated in FIG. 2, excellent anti-blocking property as described above is obtained although the reason for this is not clear. In addition, in this case, when the adhesive film 1B is applied to an object to be bonded, more excellent bonding property than that of the adhesive film 1A is obtained by providing the second adhesive layer 20.

The adhesive film 1 and the adhesive tape 33, which have been described above, are suitably used as an adhesive for electrically connecting electronic members to each other. The type of the electronic members is not particularly limited. The electronic member includes, for example, a substrate and an electrode 9 formed on one surface of the substrate. The substrate may be, for example, a substrate formed from a glass, a ceramic, polyimide, a polycarbonate, a polyester, a polyethersulfone, or the like. The electrode may be, for example, an electrode formed from gold, silver, copper, tin, aluminum, ruthenium, rhodium, palladium, osmium, iridium, platinum, indium tin oxide (ITO), or the like.

### EXAMPLES

Hereinafter, the present invention will be further specifically described on the basis of Examples; however, the present invention is not limited to the following Examples.

### Comparative Example 1

An adhesive film was prepared by the following procedure according to Examples of Patent Literature 1 described above.

First, 50 g of a phenoxy resin (product name: PKHC, weight average molecular weight: 45000, manufactured by Union Carbide Corporation) was dissolved in a mixed solvent of toluene (boiling point: 110.6° C.) and ethyl acetate (boiling point: 77.1° C.) (at a mass ratio of toluene:ethyl acetate=1:1) to obtain a phenoxy resin solution having a solid content of 40% by mass. In this phenoxy resin solution, urethane acrylate (product name: UN7700, manufactured by Negami Chemical Industrial Co., Ltd.) and phosphoric acid ester dimethacrylate (product name: Light Ester P-2M, manufactured by Kyoeisha Chemical Co., Ltd.) as a radical polymerizable substance, and 1,1-bis(t-hexylperoxy)-3,3,5-trimethylcyclohexane (product name: PERHEXA TMH, manufactured by NOF CORPORATION) as a curing agent were blended at a solid mass ratio of phenoxy resin:urethane acrylate:phosphoric acid ester dimethacrylate:curing agent=10:10:3:2 to obtain an adhesive solution.

Dendritic conductive particles (silver-coated copper particles, product name: ACBY-2, manufactured by MITSUI MINING & SMELTING CO., LTD.) were used as first conductive particles.

The second conductive particles were prepared by the following procedure.

First, benzoyl peroxide as a polymerization initiator was charged in a mixed solution of divinylbenzene, a styrene monomer, and butyl methacrylate, and polymerization reaction was performed by heating at a high speed with uniform stirring to obtain a fine particle dispersion solution. This fine particle dispersion solution was filtered and dried under reduced pressure to obtain a block body which was an aggregate of fine particles. Further, this block body was pulverized to prepare core bodies having an average particle diameter of 20 μm.

A palladium catalyst (product name: MK-2605, manufactured by Muromachi Technos Co., Ltd.) was supported on the surface of the above-described core, and the core activated with an accelerator (product name: MK-370, manufactured by Muromachi Technos Co., Ltd.) was charged in a mixed solution of a nickel sulfate aqueous solution, a sodium hypophosphite aqueous solution, and a sodium tartrate aqueous solution heated to 60° C. to perform a pre-electroless plating step. This mixture was stirred for 20 minutes, and it was confirmed that hydrogen bubbling stopped. Then, a mixed solution of nickel sulfate, sodium hypophosphite, sodium citrate, and a plating stabilizer was added and stirred until pH was stabilized, and a post-electroless plating step was performed until hydrogen bubbling stopped. Subsequently, the plating solution was filtered, and the filtrate was washed with water and then dried with a vacuum dryer at 80° C. to prepare nickel-plated second conductive particles.

45 parts by volume of the first conductive particles and 15 parts by volume of the second conductive particles were dispersed with respect to 100 parts by volume of the adhesive component to obtain a mixed solution. The obtained mixed solution was applied onto a fluororesin film (support) having a thickness of 80 μm and dried with hot air at 70° C. for 10 minutes to remove the solvent, thereby obtaining an adhesive film (adhesive tape) including a first adhesive layer having a thickness of 25 μm formed on the fluororesin film.

### Example 1

An adhesive film was obtained in the same manner as in Comparative Example 1, except that the drying conditions when the solvent was removed from the mixed solution applied on the fluororesin film were changed to drying with hot air at 90° C. for 2 minutes.

### Example 2

An adhesive film was obtained in the same manner as in Comparative Example 1, except that, when the mixed solution was obtained, 45 parts by volume of the first conductive particles and 15 parts by volume of the second conductive particles were dispersed with respect to 100 parts by volume of the adhesive component, and 30 parts by volume of acetone (boiling point: 56.1° C.) was further added.

### [Observation of Appearance]

When the surface of the adhesive film on the side opposite to the fluororesin film was observed for each adhesive film of Examples 1 and 2 and Comparative Example 1 with a laser microscope (product name: OLS40-SU, manufactured by Olympus Corporation), in Examples 1 and 2, it was confirmed that the first conductive particles and the second conductive particles protrude from the first adhesive layer; on the other hand, in Comparative Example 1, it was not confirmed that the first conductive particles and the second conductive particles protrude from the first adhesive layer.

### [Evaluation of Adhesive Force]

An aluminum foil (size: 15 mm×20 mm, thickness: 25 μm) was attached onto a copper foil (size: 40 mm×15 mm, thickness: 25 μm) with each adhesive film (size: 15 mm×3 mm) of Examples 1 and 2 and Comparative Example 1 interposed therebetween. The connection strength between the copper foil and the aluminum foil was measured by a 90-degree peeling method under the conditions of a peeling rate of 50 mm/min and 25° C. using Tensilon UTM-4 manufactured by Toyo Baldwin Co., Ltd. according the JIS Z0237. The results are shown in Table 1.

### [Evaluation of Anti-Blocking Property]

A 3-inch ABS core (manufactured by Showa Marutsutsu Co., Ltd.) was used as a core, and each adhesive tape (length: 100 m) of Examples 1 and 2 and Comparative Example 1, which had been cut to have a width of 5 mm, was wound around the core. Subsequently, disk-shaped side plates (diameter: 180 mm, thickness: 1 mm) made of polystyrene were fit to both ends of the core to prepare a reel body.

Subsequently, a SUS plate was placed in a thermostat bath (product name: Small Incubator IC-150MA, manufactured by AS ONE CORPORATION) set at 30° C., and the prepared reel body was transversely mounted on the SUS plate (the side plates of the reel body and the SUS plate were parallel to each other) and left to stand still for 72 hours in this state. After still standing, the anti-blocking property after the transverse mounting test was evaluated at 25° C. by a state when the adhesive tape was tried to be drawn from the reel body (core), on the basis of the following criteria. The results are shown in Table 1.
A: The adhesive tape could be drawn without the adhesive film being peeled off from the support.
B: A part of the adhesive film was peeled off from the support, but the adhesive tape could be drawn.
C: The adhesive tape could not be drawn.

### [Evaluation of Connection Resistance]

The connection resistance of each adhesive film of Examples 1 and 2 and Comparative Example 1 was evaluated by the following procedure. The results are shown in Table 1.

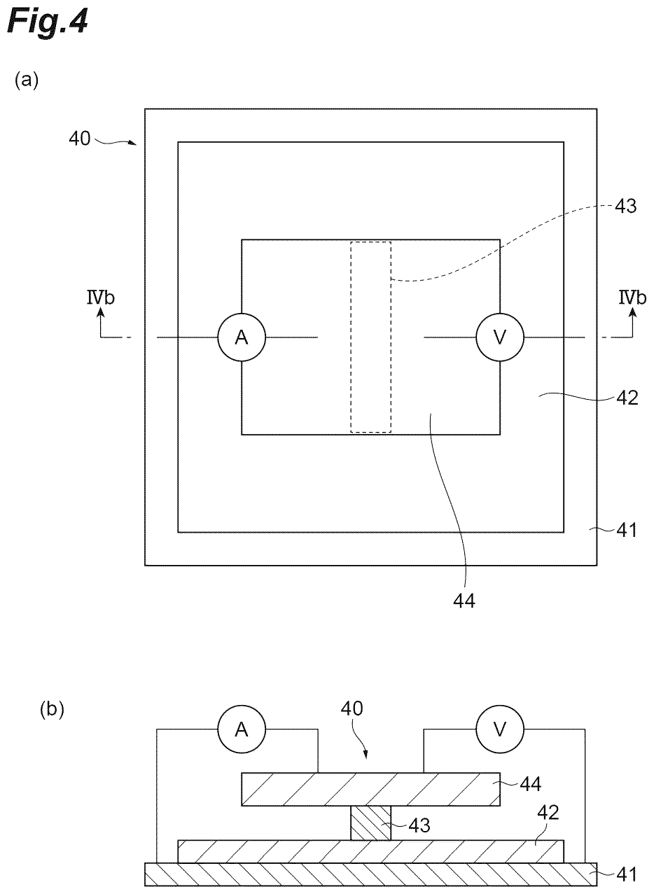

A resistance measurement sample 40 illustrated in FIG. 4 was prepared. Note that, FIG. 4(a) is a top view of the resistance measurement sample 40, and FIG. 4(b) is a cross-sectional view taken along line IVb-IVb of FIG. 4(a).

Specifically, first, a polyimide film 42 (size: 30 mm×30 mm, thickness: 25 μm) was placed on a copper foil 41 (size: 35 mm×35 mm, thickness: 25 μm). Then, an aluminum foil 44 (size: 15 mm×20 mm, thickness: 25 μm) was connected onto the polyimide film 42 with each adhesive film 43 (size: 15 mm×3 mm) of Examples 1 and 2 and Comparative Example 1 interposed therebetween. A current and a voltage between the copper foil 41 and the aluminum foil 44 were measured for each resistance measurement sample 40 thus obtained using an ammeter A and a voltmeter V, respectively, and a resistance value (initial stage) was calculated.

Subsequently, the resistance measurement sample 40 prepared as described above was subjected to a cycle test in which a heat cycle of maintaining the temperature at −20° C. for 30 minutes, increasing the temperature to 100° C. over 10 minutes, maintaining the temperature at 100° C. for 30 minutes, and decreasing the temperature to −20° C. over 10 minutes is repeated for 250 cycles, using TSA-43EL manufactured by ESPEC CORP. A resistance value (after the cycle test) was measured for each resistance measurement sample 40 after the cycle test in the same manner as described above.

### [Evaluation of Bonding Property]

The bonding property of the adhesive films of Examples 1 and 2 was also evaluated by the following procedure. The results are shown in Table 1.

Each adhesive film (adhesive tape) cut into a size of 3 mm×3 mm for each support was bonded onto a copper foil (size: 35 mm×35 mm, thickness: 25 μm). Here, heating and pressurizing when the adhesive film was bonded were performed in a state where a sheet (size: 15 mm×40 mm, thickness: 50 μm) made of Teflon (registered trademark) was placed on the adhesive film. Furthermore, the heating and the pressurizing were performed under two conditions of Condition 1 of 70° C., 1 MPa, and 2 seconds and Condition 2 of 50° C., 1 MPa, 1 second, respectively. The bonding property was evaluated by a state of the adhesive film when the support was tried to be peeled off from the adhesive film, on the basis of the following criteria.
A: The adhesive film did not float.
B: The adhesive film slightly floated.
C: The adhesive film considerably floated and wrinkles were generated.
D: The adhesive film was not peeled off from the support.

TABLE 1

| | | Comparative | | |
|---|---|---|---|---|
| | | Example 1 | Example 1 | Example 2 |
| Protrusion of conductive particles | | Absent | Present | Present |
| Second adhesive layer | | Not | Not | Not |
| | | provided | provided | provided |
| Adhesive force (N) | | 11 | 11 | 11 |
| Anti-blocking property (after still | | B | A | A |
| standing for 72 hours) | | | | |
| Connection | Initial stage | 0.17 | 0.17 | 0.18 |
| resistance (Ω) | After cycle test | 0.65 | 0.62 | 0.64 |
| Bonding | Condition 1 | — | A | A |
| property | (70° C., 1 MPa, | | | |
| | 2 seconds) | | | |
| | Condition 2 | — | B | B |
| | (50° C., 1 MPa, | | | |
| | 1 second) | | | |

As found from Table 1, despite the equal adhesive force in Comparative Example 1 and Examples 1 and 2, more excellent anti-blocking property was obtained in Examples 1 and 2 in which a part of the conductive particles is disposed to protrude from the one surface of the first adhesive layer.

### Comparative Example 2

An adhesive film was obtained in the same manner as in Comparative Example 1, except that when the adhesive solution was obtained, the solid mass ratio of a phenoxy resin, urethane acrylate, phosphoric acid ester dimethacrylate, and a curing agent was changed to phenoxy resin:urethane acrylate:phosphoric acid ester dimethacrylate:curing agent=5:14:4:2. Note that, the adhesive force of the first adhesive layer of Comparative Example 2 was higher than the adhesive force of the first adhesive layer of Comparative Example 1 by such a change.

### Example 3

An adhesive film was obtained in the same manner as in Comparative Example 2, except that the drying conditions when the solvent was removed from the mixed solution applied on the fluororesin film were changed to drying with hot air at 90° C. for 2 minutes.

### Example 4

First, an adhesive solution was obtained in the same manner as in Comparative Example 2 at a solid mass ratio of phenoxy resin:urethane acrylate:phosphoric acid ester dimethacrylate:curing agent=5:14:4:2. The obtained adhesive solution was applied to the surface of the first adhesive layer obtained in Example 1 on the side opposite to the fluororesin film and dried with hot air at 70° C. for 10 minutes to remove the solvent, thereby providing a second adhesive layer having a thickness of 2 μm on the first adhesive layer.

### Example 5

A second adhesive layer was provided on the surface of the first adhesive layer obtained in Example 2 on the side opposite to the fluororesin film in the same manner as in Example 4.

When the appearance of each adhesive film (adhesive tape) of Examples 3 to 5 and Comparative Example 2 was observed in the same manner as described above, in Example 3, it was confirmed that the first conductive particles and the second conductive particles protrude from the first adhesive layer; on the other hand, in Comparative Example 2, it was not confirmed that the first conductive particles and the second conductive particles protrude from the first adhesive layer. Furthermore, in Examples 4 and 5, it was confirmed that the surface of the second adhesive layer has a concavo-convex shape that is considered to be derived from the first conductive particles and the second conductive particles protruding from the first adhesive layer.

The evaluation of adhesive force, the evaluation of anti-blocking property, and the evaluation of connection resistance were performed for each adhesive film (adhesive tape) of Examples 3 to 5 and Comparative Example 2 in the same manner as described above. Furthermore, the bonding property of each adhesive film of Examples 3 to 5 was evaluated in the same manner as described above. However, since the blocking phenomenon was likely to occur due to a high adhesive force in each adhesive film of Examples 3 to 5 and Comparative Example 2 as compared to each adhesive film of Examples 1 and 2 and Comparative Example 1, in the evaluation of anti-blocking property, the time for still standing the reel body in the thermostat bath was changed from 72 hours to 24 hours.

TABLE 2

| | | Comparative | | | |
|---|---|---|---|---|---|
| | | Example 2 | Example 3 | Example 4 | Example 5 |
| Protrusion of conductive particles | | Absent | Present | Present | Present |
| Second adhesive layer | | Not | Not | Provided | Provided |
| | | provided | provided | | |
| Adhesive force (N) | | 14 | 14 | 13 | 13 |
| Anti-blocking property (after still | | C | B | A | A |
| standing for 24 hours) | | | | | |
| Connection | Initial stage | 0.16 | 0.18 | 0.18 | 0.17 |
| resistance (Ω) | After cycle test | 0.66 | 0.65 | 0.63 | 0.65 |
| Bonding | Condition 1 | — | A | A | A |
| property | (70° C., 1 MPa, | | | | |
| | 2 seconds) | | | | |
| | Condition 2 | — | A | A | A |
| | (50° C., 1 MPa, | | | | |
| | 1 second) | | | | |

As found from Table 2, despite the equal adhesive force in Comparative Example 2 and Examples 3 to 5, more excellent anti-blocking property was obtained in Examples 3 to 5 in which a part of the conductive particles is disposed to protrude from the one surface of the first adhesive layer.

### REFERENCE SIGNS LIST

1, 1A, 1B: adhesive film, 10: first adhesive layer, 10a: one surface of first adhesive layer, 11: first adhesive component, 12: first conductive particle, 13: second conductive particle, 20: second adhesive layer, 30: reel body, 31: core, 33: adhesive tape, 34: support.

1. A reel body comprising:
a winding core; and
an adhesive tape wound around the winding core,
wherein the adhesive tape comprises a support and an adhesive film provided on the support,
wherein the adhesive film comprises an adhesive layer,
wherein the adhesive layer comprises an adhesive component and a plurality of conductive particles,
wherein the plurality of conductive particles comprise:
first conductive particles that are dendritic conductive particles; and
second conductive particles that are conductive particles other than the first conductive particles, each second conductive particle comprising a non-conductive core and a conductive layer provided on the core,
wherein a part of the plurality of conductive particles protrudes from one surface of the adhesive layer, and
wherein the support faces a surface of the adhesive layer opposite to the one surface thereof.

2. The reel body according to claim 1, wherein a part of the first conductive particles protrudes from the one surface of the adhesive layer.

3. The reel body according to claim 1, wherein a part of the second conductive particles protrudes from the one surface of the adhesive layer.

4. The reel body according to claim 1, wherein a part of the first conductive particles and a part of the second conductive particles protrude from the one surface of the adhesive layer.

5. The reel body according to claim 1, further comprising an additional adhesive layer that is provided on the one surface of the adhesive layer and comprises an adhesive component different from the adhesive component of the adhesive layer.

6. The reel body according to claim 5, wherein the adhesive layer has a thickness of 10 μm or more, and the additional adhesive layer has a thickness of 5 μm or less.
